(19) United States
(12) Patent Application Publication
(10) Pub. No.: US 2007/0075909 A1
(43) Pub. Date: Apr. 5, 2007

(54) Integrated Satellite Communications Outdoor Unit

(75) Inventors: Stephen John Flynn, Wokingham (GB); Ronald P.A. Shiltmans, Wokingham (GB); Douglas John Cole, Wokingham (GB); David Geen, Peebles (GB)

Correspondence Address: BABCOCK IP, PLLC, P.O.BOX 488, 4934 WILDWOOD DRIVE, BRIDGMAN, MI, 49106, US

(73) Assignee: Andrew Corporation, Westchester, IL (US)

(21) Appl. No.: 11/277,300

(22) Filed: Mar. 23, 2006

Related U.S. Application Data
(60) Provisional application No. 60/596,555, filed on Oct. 3, 2005.

(51) Int. Cl. H01Q 19/12

(52) U.S. Cl. 343/840

(57) ABSTRACT

An outdoor unit for satellite communications having an integrated transceiver and LNB circuits within an outer housing that positions a feed proximate the focal point of a reflector dish. The outer housing may have an extended longitudinal dimension, coupled directly to the reflector dish or the end of a shortened boom arm. The feed may be oriented with respect to the reflector dish in an offset single or dual optic configuration. The feed and or a sub reflector may be integral with the outer housing.

### CROSS REFERENCE TO RELATED APPLICATIONS

This application claims the benefit of U.S. Provisional Patent Application No. 60/596,555, titled “Integrated Satellite Interactive Terminal”, filed Oct. 3, 2005 which is hereby incorporated by reference in the entirety.

### DESCRIPTION

### Background

Satellite communication systems are known and generally well understood. Consumer satellite communications systems such as satellite television and or internet communications typically use a first assembly, referred to as the Outdoor Unit (ODU), including receive electronics and/or transmit electronics, a feed horn and a diplexer or ortho-mode transducer (OMT) mounted on or proximate an antenna dish. The ODU is usually mounted proximate the exterior of a consumer's home, positioned in direct line of sight with a satellite. An Indoor Unit (IDU) is typically placed indoors and functions to interface the transceiver with end-user equipment. The IDU is coupled to the ODU via a communications link supplying power, control, upstream and or downstream signals over electrical and or optical cable(s).

The ODU includes an LNB (Low Noise Block Downconverter), which is a Low Noise Amplifier and downconverter that simultaneously converts the entire required frequency band received by the dish to a lower frequency for further signal processing and or distribution. The LNBF (an LNB integrated with a feed) and or LNB and feed are mounted upon the end of a boom arm that positions the feed at the focal point of the reflector dish. The prior ODUs, as shown for example in FIGS. 1 and 2, typically have a separate environmentally sealed housing 10 for the transmitter 15 that is attached either at the end or underneath the boom arm 20. The transmitter 15 is interconnected, for example by a waveguide 25, with an OMT 30 or diplexer to an LNB 35 that is then also connected to a feed 40. Alternatively, the LNB 35 and transmitter 15 have been combined in a common housing to form a transceiver, with the OMT/diplexer and feed then bolted directly to the housing, which is then mounted upon the boom arm at the focal point of the reflector dish as a unitary module having a single mounting point.

The transceiver module typically includes a heat sink to shed heat generated by the transmitter. The heat sink(s) are sized to ensure that the junction temperature of the electronic devices does not rise to a point at which reliability is compromised.

The increasing competition for reflector antennas adapted for high volume consumer applications has focused attention on improving electrical performance as well as cost reductions resulting from reduced materials and manufacturing cost as well as service efficiencies. Overall aesthetics of an ODU are also a factor for commercial success.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate embodiments of the invention and, together with the general and detailed descriptions of the invention appearing herein, serve to explain the principles of the invention.

FIG. 1 is a schematic side view of a prior art ODU.

FIG. 2 is a schematic side view of an alternative prior art ODU.

FIG. 3 is a schematic circuit diagram of an integrated transceiver and feed according to the invention.

FIG. 4 is a side view of a single optic ODU with transceiver and feed coupled to the end of a shortened boom arm according to the invention.

FIG. 5 is a front view of FIG. 4.

FIG. 6 is a side view of an alternative embodiment of a single optic ODU with transceiver and feed coupled to the end of a shortened boom arm according to the invention.

FIG. 7 is a side view of still another alternative embodiment of a single optic ODU with transceiver and feed coupled to the end of a shortened boom arm according to the invention.

FIG. 8 is a side view of a single optic ODU with transceiver and feed integrated into a common housing coupled directly to the reflector.

FIG. 9 is a side view of a dual optic ODU with sub reflector, transceiver and feed coupled to the end of a shortened boom arm according to the invention.

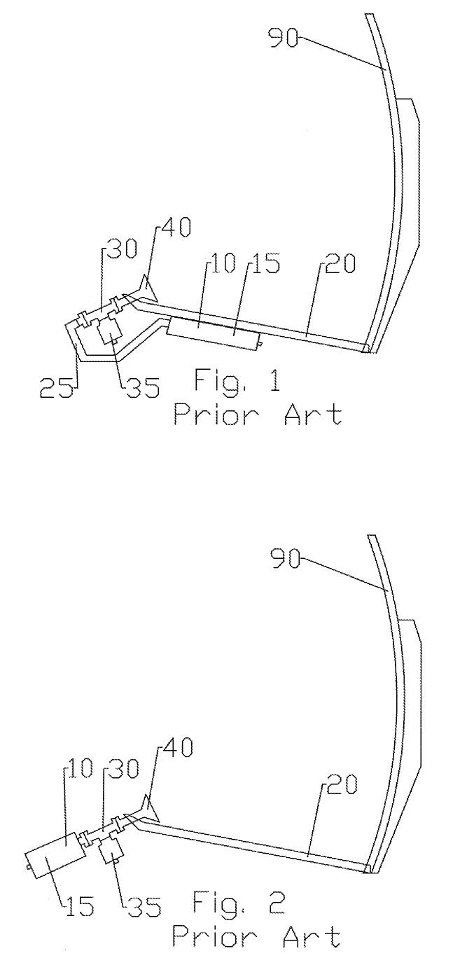

### DETAILED DESCRIPTION

A satellite interactive terminal ODU employing an integrated transceiver which incorporates transmit electronics, receive electronics, Orthogonal Mode Transducer (OMT) and transmit reject filter and which may be integrated into the structure of the satellite ODU assembly as the boom arm or attached end to end to a shortened boom arm. This affords a high level of integration, cutting installation time, inter module electrical losses and the overall cost of the ODU. Further, overall wind loads and associated structural moment arms of the resulting ODU are reduced.

The ODU integrated transceiver according to the invention may be used, for example, in a microwave or mm-wave, including Ka band satellite interactive terminal with the transmit electronics, receive electronics, (OMT) and transmit reject filter mounted on a satellite dish as a single environmentally sealed module.

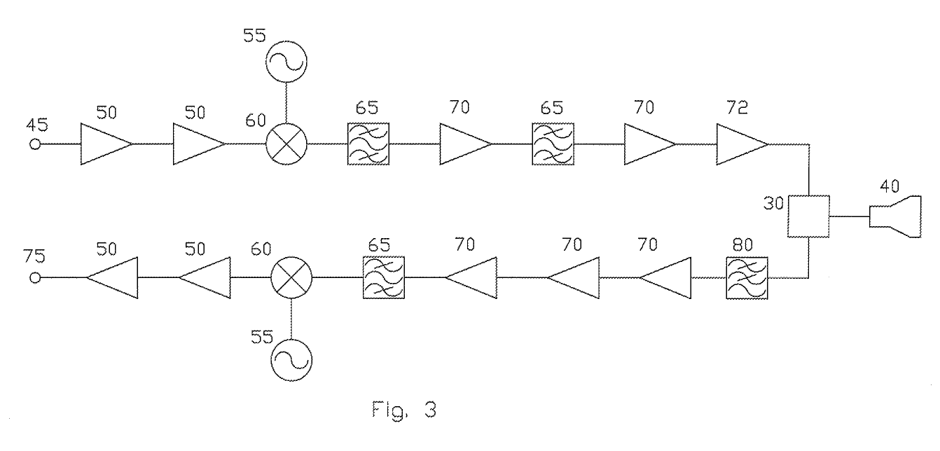

As shown in FIG. 3, the IF input signal 45 path includes preliminary IF amplifier(s) 50 that feed into a reference oscillator 55 driven mixer 60 for upconversion to the desired transmission frequencies. The upconverted signals are then fed through first and second filter 65 and amplifier 70 stages before passing through a final power amplifier 72 stage to the OMT 30 or diplexer and feed 40 horn. The diplexer is required for co-polar transmit and receive configurations and the OMT 30 in cross polar configurations.

Also as shown in FIG. 3, the RF input signal path from the OMT 30 or diplexer passes through a transmit/reject filter 80 to block passage of the outbound signals from the RF output path and then passes through one or more pre-amplifier(s) 70. The amplified signal is then passed through a frequency filter 65 before downconversion to the IDU input frequencies at a mixer 60 fed by a reference oscillator 55. Before exiting the transceiver for routing to the IDU via the IF output 75, the downconverted IF output passes through output IF amplifier(s) 50.

In both the upconversion and downconversion circuits, the reference oscillator(s) may be phase locked to improve oscillator stability. A reference signal for locking the transmit chain may be available from the IDU. The transmit reference oscillator may be dual loop phase locked to provide immunity to any phase noise on the IDU reference signal(s).

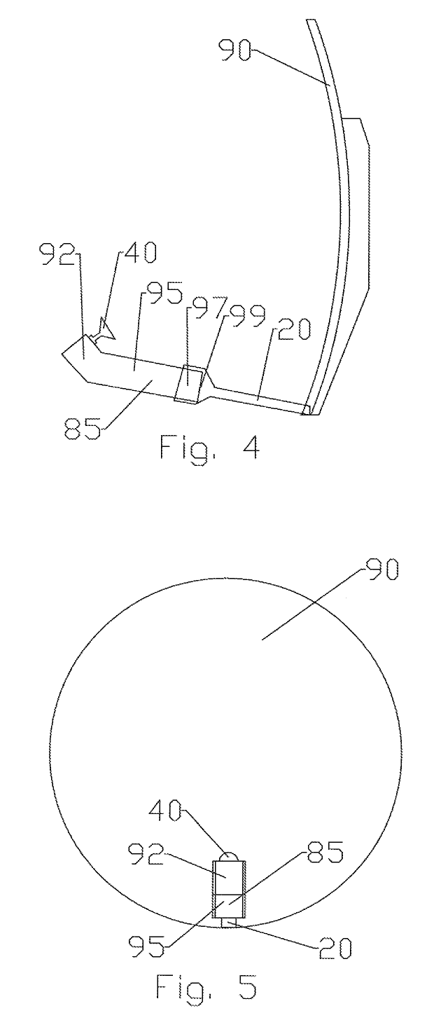

As shown in FIGS. 4-8, the ODU integrated transceiver module may be formed enclosed in an outer housing 85 having a structural aspect for replacing entirely or extending from the end of a shortened boom arm 20 of the antenna as well as a shape with minimal cross section with respect to the signal path of the reflector dish 90.

The environmentally sealed outer housing 85 of the ODU integrated transceiver module may be cost effectively formed as a cast metal component with internal chambers having waveguide and or microstrip interconnection pathways between them. Filter(s) 65 and or portions of the OMT 30 or diplexer and feed 40 horn may be cast or machined into pathways of the outer housing 85. To improve quality control and production yields, the low noise block portion of the circuitry may be formed as a single sub-block. The sub-block arrangement allowing separate sourcing, testing and or tuning of the low noise block portion prior to assembly of the ODU integrated transceiver 95.

The outer housing 85 also operates as a heat sink for heat dissipation. The position of the outer housing 85 away from the reflector in open air improves heat transfer without unacceptably increasing wind load characteristics of the ODU, overall. The outer surface(s) of the outer housing 85 may be provided with cooling fins to further optimize heat transfer away from the electrical circuitry.

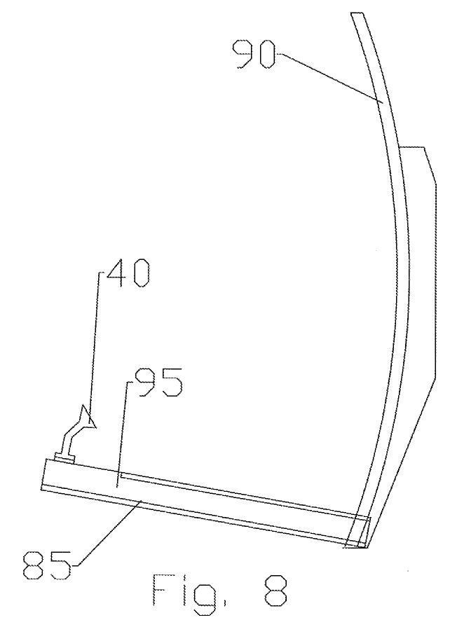

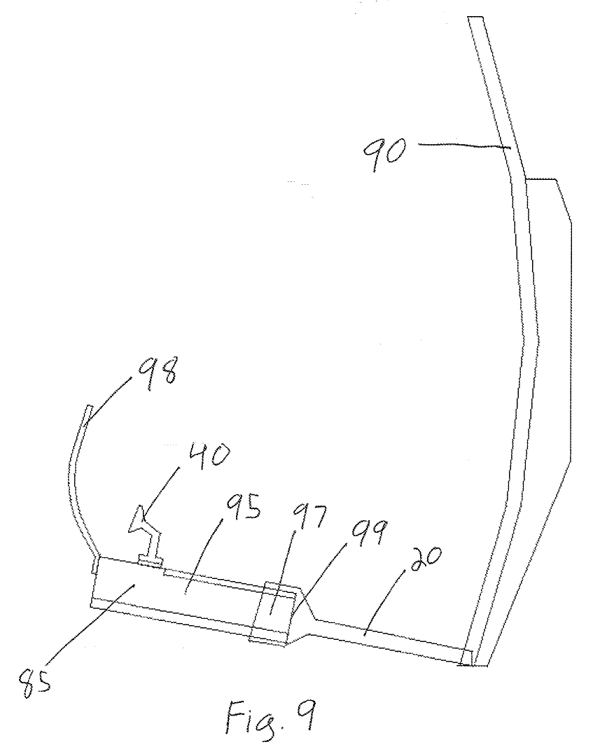

The outer housing 85 may be truncated for attachment to the end of a shortened traditional boom arm 20 or, for example as shown in FIG. 8, formed with an extended structural beam aspect to properly position the feed 40 with respect to the reflector dish 90 while entirely replacing the prior requirement for a separate boom arm. Because the same outer housing 85 may be used with reflector dish(s) 90 of different sizes having a focal point at a range of distances, a variable sized shortened boom arm 20 may be applied. Thereby, a single outer housing 85 configuration may be manufactured and the shortened boom arm 20 adjusted in length to accommodate the required focal length of the reflector dish 90. Where the outer housing 85 is attached to a shortened boom arm 20, the reflector side of the outer housing 85 may be formed with, for example, a flanged end or a keyed mating socket for simplified but secure mounting insertion of the shortened boom 20 arm retained by a fastener such as a single mounting screw. Alternatively, the mounting may be via an end plug 97 of the outer housing 85 that inserts into an open end 99 of the shortened boom arm 20.

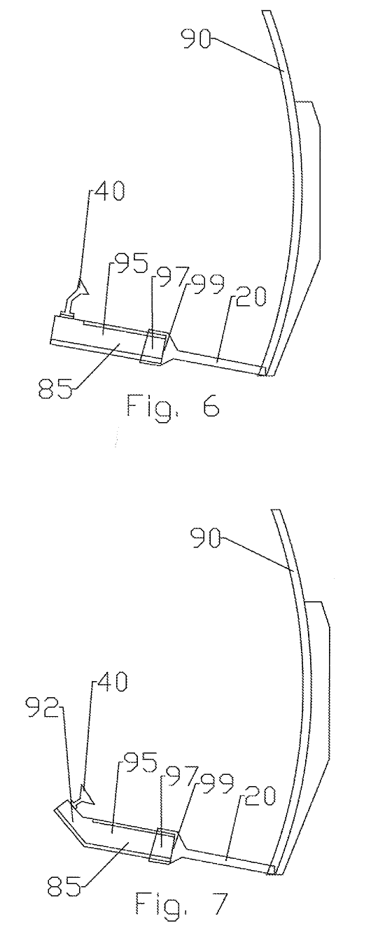

The outer housing 85 has a longitudinal axis. The interconnection between the boom arm 20 and the outer housing 85 may be end to end such that the outer housing 85 and boom arm 20 share a common longitudinal axis. Thereby, the resulting ODU has a minimal cross sectional area and a highly aesthetic streamlined appearance. The feed 40 may be attached to an end of the outer housing 85 to a surface parallel to the longitudinal axis as shown for example in FIGS. 6 and 8, or to an angled portion 92 of the outer housing 85 that extends away from the longitudinal axis as shown for example in FIGS. 4 and 7.

The invention may also be configured in a dual optic configuration, for example as shown in FIG. 9. A sub reflector 98 is positioned to re-direct signals between the reflector dish 90 and the feed 40. The sub reflector 98 may be coupled to the outer housing 85 or formed as an integral extension of the outer housing 85, further reducing separate part and fastener requirements. In the integrated configuration, the sub reflector 98 also serves as a heat sink for the outer housing 85.

Because the components are applied in close proximity, prior requirements for multiple environmentally sealed inter-module interconnection(s) and the transmission losses and costs associated therewith are reduced. Also, because the ODU integrated transceiver is itself integrated into the boom arm, the mechanical structure forming the boom arm extension and or an end to end replacement thereof may be utilized as a heat sink advantageously located in the open air and having reduced wind load and or snow/ice accumulation characteristics. The shortened length required for the boom arm 20 will also be lower cost than a conventional full length boom arm. Further, the assembly requirements of an ODU according to the invention are significantly reduced as the prior plurality of fasteners previously applied between the separate components and the boom arm 20 are eliminated.

Finally, the aesthetics of the ODU are greatly increased, because the prior plurality of fasteners, inter-module cabling and clunky appearance in general of the separate modules slung along a significantly larger boom arm and or behind the reflector dish 90 has been eliminated.

Table of Parts

| | |
|---|---|
| 10 | housing |
| 15 | transmitter |
| 20 | boom arm |
| 25 | waveguide |
| 30 | OMT |
| 35 | LNB |
| 40 | feed |
| 45 | IF input signal |
| 50 | IF amplifier |
| 55 | oscillator |
| 60 | mixer |
| 65 | filter |
| 70 | amplifier |
| 72 | power amplifier |
| 75 | IF output signal |
| 80 | transmit/reject filter |
| 85 | outer housing |
| 90 | reflector dish |
| 95 | transceiver |
| 97 | end plug |
| 98 | sub reflector |
| 99 | open end |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

What is claimed is:

1. An outdoor unit for satellite communications, comprising:
A reflector dish;
an integrated transceiver module with an outer housing enclosing a transceiver circuit(s) and supporting a feed;
the outer housing directly coupled to the reflector, positioning the feed proximate a focal point of the reflector dish.

2. The outdoor unit of claim 1, wherein the outer housing is a metal casting.

3. The outdoor unit of claim 1, wherein the feed is integral with the outer housing.

4. The outdoor unit of claim 1, wherein the transceiver has a phase locked reference oscillator in a receive path.

5. The outdoor unit of claim 1, wherein the transceiver has a dual loop phase locked loop in a transmit path.

6. The outdoor unit of claim 1, wherein the LNB circuit is a module insertable into a chamber of the outer housing.

7. The outdoor unit of claim 1, wherein the reflector dish and feed are in a single optic offset configuration.

8. The outdoor unit of claim 1, further including a sub reflector coupled to the outer housing;
the reflector dish and feed horn in a dual optic offset configuration via the sub reflector.

9. The outdoor unit of claim 7, wherein the sub reflector is integral with the outer housing.

10. An outdoor unit for satellite communications, comprising:
A reflector dish;
an integrated transceiver module with an outer housing enclosing a transceiver circuit(s) and supporting a feed;
the outer housing coupled to the end of a boom arm projecting from the reflector, positioning the feed proximate a focal point of the reflector dish.

11. The outdoor unit of claim 10, wherein the outer housing has a mating socket into which the end of the boom arm is inserted.

12. The outdoor unit of claim 10, wherein the outer housing has an end plug that inserts into an open end of the boom arm.

13. The outdoor unit of claim 10, wherein the outer housing is retained upon the end of the boom arm via a single fastener.

14. The outdoor unit of claim 10, wherein the outer housing and the boom arm are coupled end to end, sharing a common longitudinal axis.

15. An outdoor unit for satellite communications, comprising:
A reflector dish;
an integrated transceiver module with an outer housing enclosing a transceiver circuit(s) and supporting a feed;
the outer housing having a longitudinal axis along which an end of the outer housing is directly coupled to an end of a boom arm projecting from the reflector dish, positioning the feed proximate a focal point of the reflector dish.

16. The outdoor unit of claim 15, wherein the outer housing has a mating socket into which the end of the boom arm is inserted.

17. The outdoor unit of claim 15, wherein the outer housing has an end plug that inserts into an open end of the boom arm.

18. The outdoor unit of claim 15, wherein the feed is coupled to the outer housing at a surface of the outer housing parallel to the longitudinal axis.

19. The outdoor unit of claim 15, wherein the feed is coupled to the outer housing at an angled portion of the outer housing.

20. The outdoor unit of claim 15, wherein the feed is in the form of a horn.
